(19) United States
(12) Patent Application Publication
(10) Pub. No.: US 2014/0093620 A1
(43) Pub. Date: Apr. 3, 2014

(54) READY TO EAT COLD CEREAL CAKES WITH INGREDIENTS

(71) Applicant: Alice Chang, South Pasadena, CA (US)

(72) Inventor: Alice Chang, South Pasadena, CA (US)

(21) Appl. No.: 13/928,389

(22) Filed: Jun. 27, 2013

Related U.S. Application Data
(60) Provisional application No. 61/708,420, filed on Oct. 1, 2012.

(51) Int. Cl. A23L 1/182

(52) U.S. Cl. CPC A23L 1/182
USPC 426/96; 426/618

(57) ABSTRACT

Cold and ready to eat cereal cakes, with a variety of ingredient combinations suitable for healthy consumption. Serving size can be a single serving, or a six pack of servings for convenience such that the inherent nutritional aspects of cereals are able to be included in consumer's diets.

### CROSS-REFERENCE TO RELATED APPLICATION

The present application is related to and claims priority from prior provisional application Ser. No. 61/708,420 filed Oct. 1, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of comestibles and more specifically relates to ready to eat cold cereal cakes.

2. Description of the Related Art

It is desirable to offer nutritious comestibles for consumption. Nutrition, if maintained, may help individuals avoid serious health problems. Cereals are a healthy food choice; however they may not typically be offered in a conveniently readily edible form. For example many individuals eat cereal in some form for breakfast; however cereal in this traditional manner is not conducive to portability and is thus often eaten in the home before leaving for the day. Cereals are an important source of protein and carbohydrates and are widely available for consumption. Further, cereals have significant amounts of fiber and soluble fiber, with one cup of cooked cereals providing between nine and thirteen grams of fiber. Soluble fiber can help lower blood cholesterol. Since people's schedules are busy, convenience may outweigh nutrition which is not desirable in the long-term. It is desirable to have foods such as cereals that are nutritious and also convenient to eat. A more efficient option is needed wherein cereals can be produced in such a form.

Various attempts have been made to solve the above-mentioned problems such as those found in U.S. Pat. Nos. and Pub. Nos. 2003/0147999; 5,871,793; 6,248,379; 2005/0142262; 2009/0053379; and 2012/0269939. This art is representative of comestibles relating to cereals. None of the above inventions and patents, taken either singly or in combination, is seen to describe the invention as claimed.

Ideally, ready to eat cold cereal cakes should provide nutrition and convenience to consumers and, yet would be manufactured at a modest expense. Thus, a need exists for ready to eat cold cereal cakes to avoid the above-mentioned problems.

### BRIEF SUMMARY OF THE INVENTION

In view of the foregoing disadvantages inherent in the known cereal-related comestibles art, the present invention provides novel ready to eat cold cereal cakes. The general purpose of the present invention, which will be described subsequently in greater detail is to provide ready to eat cold cereal cakes with a variety of ingredients. The invention is to provide people who shop for cereals grains for food the option of getting processed and cooked cereal cakes, cold and ready to eat.

A ready to eat cold cereal cake product comprising ingredients is disclosed herein combined in proportions substantially including: at least one cereal; milk; a binding agent; additives; and flavorings. The cereal, milk, binding agent, additives and flavorings are stirred, mixed as an admixture and cooked to form cereal cakes as a ready to eat cold cereal cake product. The binding agent causes the admixture to congeal (after being cooked) when the admixture is cooled using refrigeration. The flavorings cause the cereal cakes to be flavored (as per consumer preference) for consumption; the cereal cakes are high in nutrition and suitable for readily consuming Various flavored versions of the cereal cakes may be produced. Kits may be packaged with ingredients and sold for home cooking.

A method of preparing ready to eat cold cereal cakes comprises the steps of: stirring and mixing cereal grains with ingredients, seasonings, and a binding agent as an admixture; boiling until texture of admixture is soft and smooth; removing remaining solid residues; forming cereal cakes; storing the cereal cakes in a refrigerator to congeal and solidify; and optionally packaging to preserve freshness once solidified (before consumption).

The present invention holds significant improvements and serves as a ready to eat cold cereal cakes system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat cold cakes, constructed and operative according to the teachings of the present invention.

FIG. 1 shows a perspective view illustrating ready to eat cold cereal cakes according to an embodiment of the present invention.

FIG. 2 is a perspective view illustrating the ready to eat cold cereal cakes according to an embodiment of the present invention of FIG. 1.

FIG. 3 is a flowchart illustrating a method of preparing the ready to eat cold cereal cakes according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to a comestible and more particularly to ready to eat cold cereal cakes as used to improve the health of consumers. The purpose as previously mentioned is to create healthy comestibles; ready to eat cold cereal cakes, and with a variety of ingredients.

Generally speaking, the cereal grains used herein can include corn, wheat, oat, barley, rye, rice, buckwheat, millet, sorghum, and the like; other cereals may be used in alternate embodiments. The cereal grains are stirred and mixed with the ingredients, seasonings, and binding agent, and boiled until the texture is soft and smooth, and any remaining solid residues can be removed. When the binding agent is a starch component and/or egg white instead of gelatin, the cereal cakes and cereal cakes can be reheated in the microwave oven or conventional oven.

The cereal cakes are stored in the refrigerator to congeal or solidify, and are ready to eat. The cereal cakes may be cooked and eaten or packaged into air-tight containers to preserve freshness for storage or shipping. The containers can be made of paper, plastic, glass, metal. The serving size can be a single serving, or a six pack of servings. Each serving can be contained in a cubical shaped (or other shaped) container, with each side of the container about 3 to 4 inches in length.

Cold and ready to eat cereal cakes save people the time and energy of preparing and cooking of the food. They can be served as food for breakfast, lunch, snack, or dinner. Cold and ready to eat cereal cakes offer the consumers an easy and convenient way to obtain an affordable, nutritious and delicious meal.

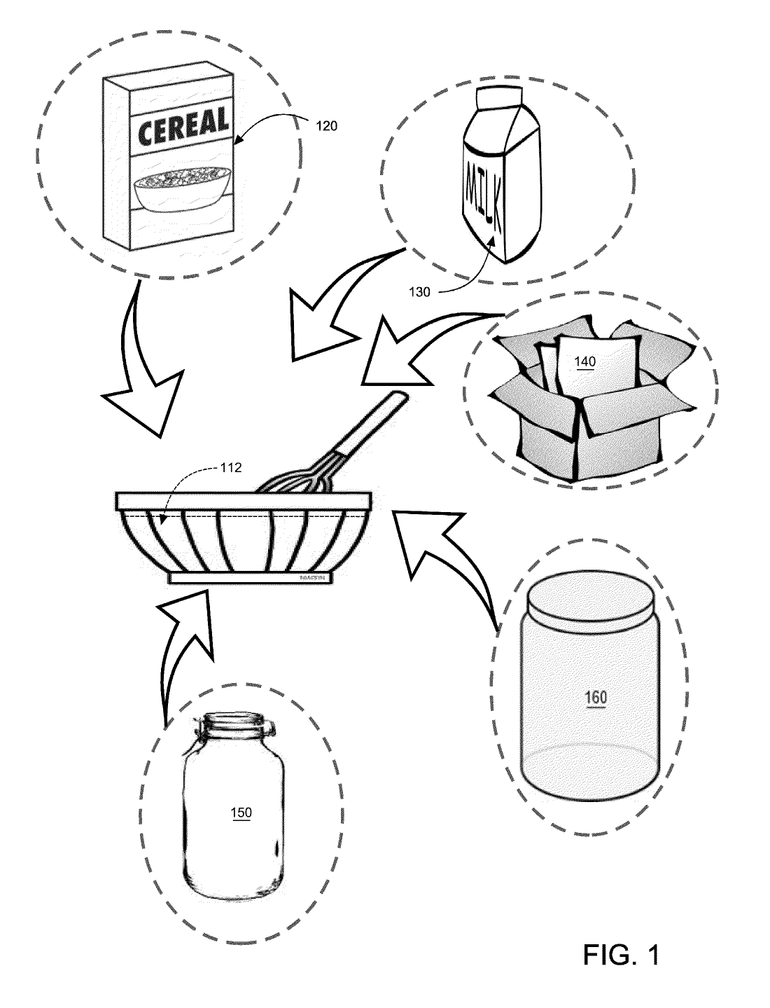

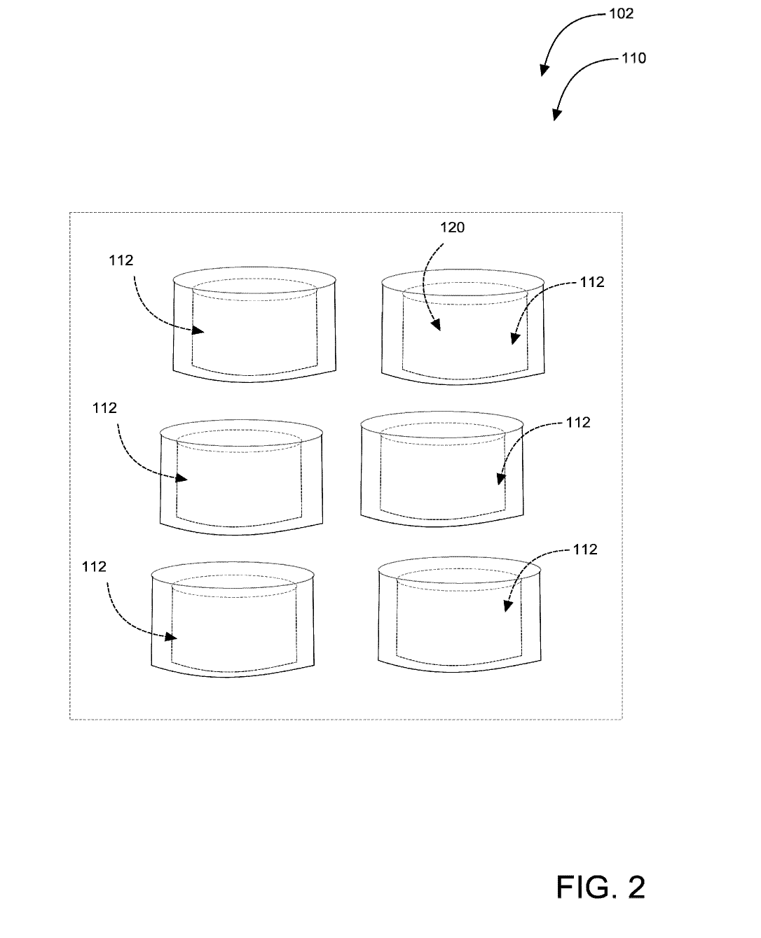

Referring to the drawings by numerals of reference there is shown in FIGS. 1-2, perspective views illustrating ready to eat cold cereal cakes 110 according to embodiments of the present invention.

Ready to eat cold cereal cake product 102 comprises ingredients combined in proportions substantially including: at least one cereal 120; milk 130; binding agent 140; additives 150; and flavorings 160; wherein at least one cereal 120; milk 130; binding agent 140; additives 150; and flavorings 160 are stirred, mixed as an admixture and cooked to form cereal cakes 112 as ready to eat cold cereal cake product 102.

Cereals 120 are preferably selected from the group consisting of corn, wheat, oat, barley, rye, rice, buckwheat, millet, and sorghum, as previously mentioned. Milk 130, when used is preferably selected from the group consisting of whole milk, lowfat milk, nonfat milk, soy milk, coconut milk, almond milk, and vanilla milk. Other suitably flavored milk 130 may be used.

Binding agent 140 causes admixture to congeal after being cooked when the admixture is cooled using refrigeration means. Binding agent 140 is an edible binder and may comprise gelatin and/or egg white since it is high in protein. The binding agent 140 as an edible binder may alternately comprise a starch component. Binding agent 140 may be selected from the group consisting of gelatin, egg white, corn starch, potato starch, sago, and tapioca.

Flavorings 160 cause cereal cakes 112 to be appropriately flavored for consumption. Flavorings 160 are preferably selected from the group consisting of salt, pepper, garlic, ginger, onion, chili, curry, vinegar, lemon, lime, basil, thyme, rosemary, parsley, peppermint, and soup stock. Cereal cakes 112 are high in nutrition due to their high cereal content and suitable for readily consuming Ready to eat cold cereal cake product 102 may further comprise fruit juice to make fruity flavored versions of cereal cakes 112; wherein fruit juices are selected from the group consisting of apple juice, orange juice, lemon juice, lime juice, grapefruit juice, grape juice, pear juice, cranberry juice, blueberry juice, pineapple juice, pomegranate juice, and coconut juice.

Ready to eat cold cereal cake product 102 may comprise additives 150 which are preferably selected from the group consisting of coffee, tea, chocolate, caramel, butterscotch, raisin, fruit, nut, vegetable oil, cream, butter, peanut butter, cheese, and egg.

Ready to eat cold cereal cake product 102, as disclosed herein, may further comprise at least one topping; wherein the topping(s) may be selected from the group consisting of chocolate, caramel, butterscotch, apple sauce, fruit, nut, cheese, and cream. The toppings generally produce a sweet version of ready to eat cold cereal cake product 102. Alternately, ready to eat cold cereal cake product 102 may further comprise a salt source, which can make up of ingredients that are cooked and seasoned. When used, the salt source is preferably selected from the group consisting of vegetables, seafood, meat, cheese, and egg; the salt source cut into small pieces. This provides a salty version that may suit the individual taste of the consumer.

Vegetables, when used are preferably selected from the group consisting of onion, garlic, mushroom, spinach, carrot, pea, corn, beet, radish, turnip, pepper, tomato, asparagus, cucumber, zucchini, eggplant, and squash. Other vegetables and salt sources may be used. In this way the present invention is very versatile in taste and preparation.

In yet other embodiments, ready to eat cold cereal cake product 102 may further comprise at least one seafood; wherein the seafood is selected from the group consisting of squid, cuttle fish, shrimp, crab, crayfish, octopus, clam, oyster, scallop, lobster, abalone, conch, jellyfish, shrimp roe, fish roe, and fish. Other fish and seafood(s) may be included. Meat may also be included within the present recipe. In these embodiments meat is preferably selected from the group consisting of chicken, pork, beef, lamb, bacon, and sausage; however other meats or combinations thereof may be used.

Examples: an example of cereal cake is made with oat, milk and gelatin. Another example of cereal cake is made with rice, almond milk and gelatin. Yet another example of cereal cake is made with wheat, milk, pea, carrot and gelatin. An example of sweet cereal cake is made with corn, soy milk, honey, ginger, lime juice and gelatin. Another example of sweet cereal cake is made with rice, coconut milk, sugar, butter, gelatin, and egg white. An example of fruity cereal cake is made with oat, milk, apple juice, sago, and gelatin. An example of salty cereal cake is made with rye, milk, bacon, onion, salt, garlic, olive oil, gelatin, and corn starch. An example of salty and spicy cereal cake is made with barley, milk, shrimp, salt, ginger, chili, vinegar, flaxseed oil and gelatin. Many other examples can be produced; however these provide a general exemplary means for preparing the present invention.

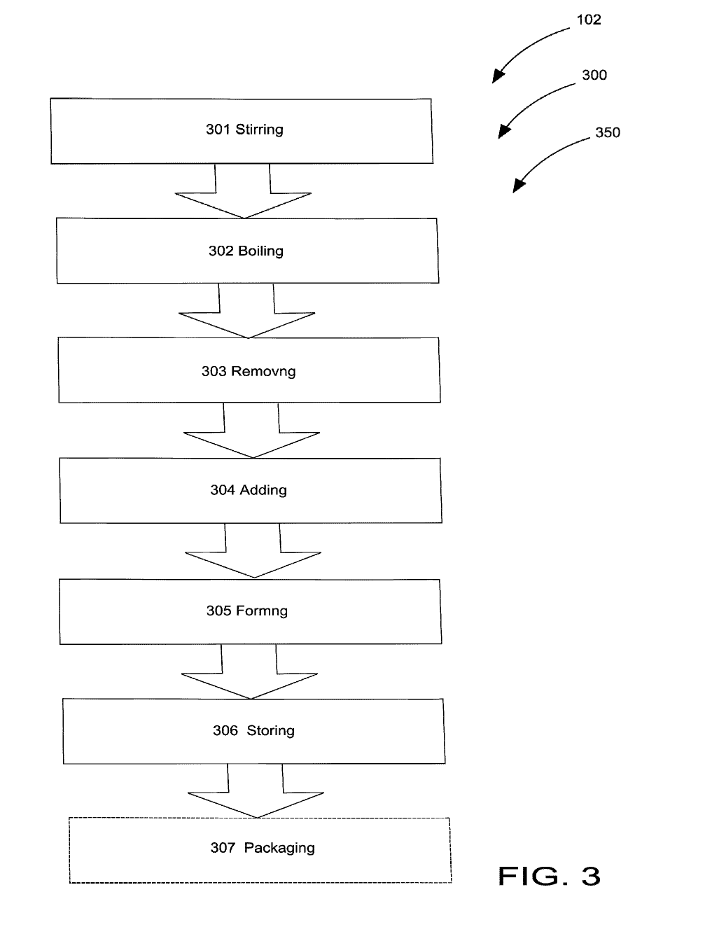

Referring now to FIG. 3, a flowchart 350 illustrating method of preparing 300 ready to eat cold cereal cakes 110 according to an embodiment of the present invention of FIGS. 1-2.

Method of preparing 300 ready to eat cold cereal cakes 102 comprises the steps of: step one 301 stirring and mixing cereal grains 120 with milk or water; step two 302 boiling until the texture of the admixture is soft and smooth; step three 303 removing remaining solid residues; step four 304 adding ingredients, seasonings, and binding agent 140 as an admixture; step five 305 forming cereal cakes 112; step six 306 storing cereal cakes 112 in a refrigerator to congeal and solidify; and optionally step seven 307 packaging to preserve freshness once solidified.

It should be noted that step 307 is an optional step and may not be implemented in all cases. Optional steps of method 300 are illustrated using dotted lines in FIG. 3 so as to distinguish them from the other steps of method 300.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat cold cereal cake product comprising ingredients combined in proportions substantially including:
at least one cereal;
milk;
a binding agent;
additives; and
flavorings;
wherein said cereal(s), said milk, said binding agent, said additives and said flavorings are stirred, mixed as an admixture and cooked to form cereal cakes as said ready to eat cold cereal cake product;
wherein said binding agent causes said admixture to congeal after being cooked when said admixture is cooled using refrigeration;
wherein said flavorings cause said cereal cakes to be flavored for consumption; and
wherein said cereal cakes are high in nutrition and suitable for readily consuming.

2. The ready to eat cold cereal cake product of claim 1 wherein said binding agent is an edible binder and comprises gelatin high in protein.

3. The ready to eat cold cereal cake product of claim 1 wherein said binding agent is an edible binder and comprises a starch component.

4. The ready to eat cold cereal cake product of claim 1 wherein said binding agent selected from the group consisting of gelatin, corn starch, potato starch, saga, and tapioca.

5. The ready to eat cold cereal cake product of claim 1 wherein said flavorings are selected from the group consisting of salt, pepper, garlic, ginger, onion, chili, curry, vinegar, lemon, lime, basil, thyme, rosemary, parsley, peppermint, and soup stock.

6. The ready to eat cold cereal cake product of claim 1 further comprising a topping.

7. The ready to eat cold cereal cake product of claim 6 wherein said topping is selected from the group consisting of chocolate, caramel, butterscotch, apple sauce, fruit, nut, cheese, and cream.

8. The ready to eat cold cereal cake product of claim 1 further comprising a salt source.

9. The ready to eat cold cereal cake product of claim 8 wherein said salt source is selected from the group consisting of vegetables, seafood, meat, cheese, and egg, said salt source cut into small pieces.

10. The ready to eat cold cereal cake product of claim 9 wherein said vegetables are selected from the group consisting of onion, garlic, mushroom, spinach, carrot, pea, corn, beet, radish, turnip, pepper, tomato, asparagus, cucumber, zucchini, eggplant, and squash.

11. The ready to eat cold cereal cake product of claim 1 of claim 1 further comprising at least one seafood.

12. The ready to eat cold cereal cake product of claim 11 wherein said at least one seafood is selected from the group consisting of squid, cuttle fish, shrimp, crab, crayfish, octopus, clam, oyster, scallop, lobster, abalone, conch, jellyfish, shrimp roe, fish roe, and fish.

13. The ready to eat cold cereal cake product of claim 1 wherein said milk is selected from the group consisting of whole milk, lowfat milk, nonfat milk, soy milk, coconut milk, almond milk, and vanilla milk.

14. The ready to eat cold cereal cake product of claim 1 wherein said cereals are selected from the group consisting of corn, wheat, oat, barley, rye, rice, buckwheat, millet, and sorghum.

15. The ready to eat cold cereal cake product of claim 1 further comprising fruit juice to make fruity flavored said cereal cakes.

16. The ready to eat cold cereal cake product of claim 15 wherein said fruit juices are selected from the group consisting of apple juice, orange juice, lemon juice, lime juice, grapefruit juice, grape juice, pear juice, cranberry juice, blueberry juice, pineapple juice, pomegranate juice, and coconut juice.

17. The ready to eat cold cereal cake product of claim 1 wherein said additives are selected from the group consisting of coffee, tea, chocolate, caramel, butterscotch, raisin, fruit, nut, vegetable oil, cream, butter, peanut butter, cheese, and egg.

18. The ready to eat cold cereal cake product of claim 1 further comprising meat.

19. The ready to eat cold cereal cake product of claim 18 wherein said meat is selected from the group consisting of chicken, pork, beef, lamb, bacon, and sausage.

20. A method of preparing ready to eat cold cereal cakes comprising the steps of:
stirring and mixing cereal grains with ingredients, seasonings, and binding agent as an admixture;
boiling until texture of said admixture is soft and smooth;
removing remaining solid residues;
adding ingredients, seasonings, and binding agent as an admixture;
forming cereal cakes;
storing the cereal cakes in a refrigerator to congeal and solidify; and
packaging to preserve freshness once solidified.
